(19) United States
(12) Patent Application Publication
(10) Pub. No.: US 2013/0096251 A1
(43) Pub. Date: Apr. 18, 2013

(54) CURABLE SILYL POLYMERS

(71) Applicants: Paul J. Popa, Auburn, MI (US); Gary E. Spilman, Midland, MI (US); Zenon Lysenko, Midland, MI (US); William A. Koonce, Pearland, TX (US); David A. Bobb, Lake Jackson, TX (US); Martin C. Beebe, Standish, MI (US); Thomas C. Thyne, Midland, MI (US)

(72) Inventors: Paul J. Popa, Auburn, MI (US); Gary E. Spilman, Midland, MI (US); Zenon Lysenko, Midland, MI (US); William A. Koonce, Pearland, TX (US); David A. Bobb, Lake Jackson, TX (US); Martin C. Beebe, Standish, MI (US); Thomas C. Thyne, Midland, MI (US)

(73) Assignee: Dow Global Technologies LLC, Midland, MI (US)

(21) Appl. No.: 13/700,961

(22) PCT Filed: Jun. 21, 2011
(86) PCT No.: PCT/US2011/041179

§ 371 Date: Nov. 29, 2012

Related U.S. Application Data
(60) Provisional application No. 61/357,131, filed on Jun. 22, 2010.

(51) Int. Cl. C08G 18/83; C08G 18/12

(52) U.S. Cl. CPC C08G 18/837; C08G 18/12
USPC 524/588; 525/450

(57) ABSTRACT

Embodiments of the invention relate to crosslinkable silyl group-containing polymers and methods of producing them. In one embodiment a method of producing a silyl polymer is provided. The method includes reacting at least one natural oil based polyol with at least one isocyanate to form at least one prepolymer having at least one NCO group. The at least one natural oil based polyol includes the reaction product of hydroxymethylated fatty acids or esters thereof and at least one polyol initiator. The prepolymer having at least one NCO group is reacted with at least one amino functional alkoxy silane to form the silyl polymer, such that the silyl polymer includes at least one crosslinkable silyl group, at least one urethane group, and at least one urea group in each molecule.

### CROSS-REFERENCE TO RELATED APPLICATIONS

This application claims the benefit of U.S. Provisional Patent Application No. 61/357,131, filed on Jun. 22, 2010, and fully incorporated herein by reference.

### FIELD OF THE INVENTION

Embodiments of the invention relate to crosslinkable silyl group-containing polymers and methods of producing them.

### BACKGROUND OF THE INVENTION

Crosslinkable silyl group-containing polymers are widely used as raw material polymers in sealing materials, adhesives, coating materials and the like for architectural or industrial use. Such crosslinkable silyl group-containing polymers may be produced according to various methods. Many of these polymers are mostly based on polyethers (ethylene oxide/propylene oxide polymers) derived from petroleum feedstocks. The polymers are linear well-defined, high molecular weight intermediates, which have easy processability into standard sealant formulations. However, these sealants may be hydrophilic and, as such may demonstrate moisture uptake, mold growth and easy dirt pick up. In addition, the volatility of petroleum feedstock pricing and availability severely impacts the margins and pricing for these sealants.

Therefore there is a need for method for producing crosslinkable silyl group-containing polymers which includes materials based renewable feedstocks while at the same time maintaining or exceeding the physical and/or chemical properties of the end product.

### SUMMARY OF THE INVENTION

Embodiments of the invention relate to crosslinkable silyl group-containing polymers and methods of producing them. In one embodiment, a method of producing a silyl polymer is provided. The method includes reacting at least one natural oil based polyol with at least one isocyanate to form at least one prepolymer having at least one NCO group. The at least one natural oil based polyol includes the reaction product of hydroxymethylated fatty acids or esters thereof and at least one polyol initiator. The prepolymer having at least one NCO group is reacted with at least one amino functional alkoxy silane to form the silyl polymer, such that the silyl polymer includes at least one crosslinkable silyl group, at least one urethane group, and at least one urea group in each molecule.

In one embodiment, a silyl polymer is provided. The silyl polymer includes the reaction product of at least a) and b):

a) is at least one prepolymer having at least one free NCO group. The at least one prepolymer includes the reaction product of at least one natural oil based polyol and at least one isocyanate. The at least one natural oil based polyol includes the reaction product of hydroxymethylated fatty acids or esters thereof and at least one polyol initiator.

b) is at least one amino functional alkoxy silane. The silyl polymer includes at least one crosslinkable silyl group, at least one urethane group, and at least one urea group in each molecule.

In one embodiment, at least about 50 weight percent of the hydroxymethylated fatty acids or esters thereof is methyl 9 (10) hydroxymethylstearate.

In one embodiment, at least about 80 weight percent of the hydroxymethylated fatty acids or esters thereof is methyl 9 (10) hydroxymethylstearate.

In one embodiment, the hydroxymethylated fatty acids or esters thereof is prepared from an oil having fatty acids or fatty acid esters which are at least about 80 weight percent oleic acid or esters thereof and which has an average hydroxyl functionality of from 1.5 to 4.

In one embodiment, the at least one isocyanate is a NCO-terminated polyether prepolymer.

In one embodiment, the polyol initiator is a poly(tetramethylene ether glycol).

In one embodiment, the silyl polymer is cured with water.

In one embodiment, the silyl polymer is cured with water to form a cured product which has a Tensile strength as measured according to the procedures of ASTM D412 of at least about 0.25 MPa.

In one embodiment, the silyl polymer is cured with water to form a cured product which has an elongation as measured according to the procedures of ASTM D412 of at least about 10 percent.

In one embodiment, the cured product is an elastomer, a sealant, an adhesive, a coating or a combination thereof.

### DESCRIPTION OF EMBODIMENTS OF THE INVENTION

Embodiments of the invention provide for methods producing crosslinkable silyl group-containing polymers which includes materials based renewable feedstocks while at the same time maintaining or exceeding the physical and/or chemical properties of the end product as compared to end products made from polymers which do not include materials based renewable feedstocks.

The crosslinkable silyl group-containing polymers may be a reaction product of at least one NCO terminated prepolymer of a natural oil based polyol and at least one amino functional alkoxysilane. The NCO terminated prepolymer may be the reaction product of an isocyanate and polyol composition which includes at least one natural oil based polyol.

Natural oil based polyols (NOBP) are polyols based on or derived from renewable feedstock resources such as natural plant vegetable seed oils. The renewable feedstock resources may also include genetically modified (GMO) plant vegetable seed oils and/or animal source fats. Such oils and/or fats are generally comprised of triglycerides, that is, fatty acids linked together with glycerol. Preferred are vegetable oils that have at least about 70 percent unsaturated fatty acids in the triglyceride. Preferably the natural product contains at least about 85 percent by weight unsaturated fatty acids. Examples of preferred vegetable oils include, for example, those from castor, soybean, olive, peanut, rapeseed, corn, sesame, cotton, canola, safflower, linseed, palm, grapeseed, black caraway, pumpkin kernel, borage seed, wood germ, apricot kernel, pistachio, almond, macadamia nut, avocado, sea buckthorn, hemp, hazelnut, evening primrose, wild rose, thistle, walnut, sunflower, jatropha seed oils, or a combination thereof. Examples of animal products include lard, beef tallow, fish oils and mixtures thereof. Additionally, oils obtained from organisms such as algae may also be used. A combination of vegetable, algae, and animal based oils/fats may also be used.

For use in the production of polyurethane products, the natural material may be modified to give the material isocyanate reactive groups or to increase the number of isocyanate reactive groups on the material. Preferably such reactive groups are a hydroxyl group.

The modified natural oil derived polyols may be obtained by a multi-step process wherein the animal or vegetable oils/fats are subjected to transesterification and the constituent fatty acids recovered. This step is followed by hydroformylating carbon-carbon double bonds in the constituent fatty acids followed by reduction to form hydroxymethyl groups. Suitable hydroformylation/reduction methods are described in U.S. Pat. Nos. 4,731,486, 4,633,021, and 7,615,658, for example. The hydroxymethylated fatty acids or esters thereof are herein labeled “monomers” which form one of the building blocks for the natural oil based polyol. The monomers may be a single kind of hydroxymethylated fatty acid and/or hydroxymethylated fatty acid methyl ester, such as hydroxymethylated oleic acid or methylester thereof, hydroxymethylated linoleic acid or methylester thereof, hydroxymethylated linolenic acid or methylester thereof, α- and γ-linolenic acid or methyl ester thereof, myristoleic acid or methyl ester thereof, palmitoleic acid or methyl ester thereof, oleic acid or methyl ester thereof, vaccenic acid or methyl ester thereof, petroselinic acid or methyl ester thereof, gadoleic acid or methyl ester thereof, erucic acid or methyl ester thereof, nervonic acid or methyl ester thereof, stearidonic acid or methyl ester thereof, arachidonic acid or methyl ester thereof, timnodonic acid or methyl ester thereof, clupanodonic acid or methyl ester thereof, cervonic acid or methyl ester thereof, or hydroxymethylated ricinoleic acid or methylester thereof. In one embodiment, the monomer is hydroformulated methyloelate. Alternatively, the monomer may be the product of hydroformulating the mixture of fatty acids recovered from transesterifaction process of the animal or vegetable oils/fats to form hydroxymethylated fatty acids or methyl esters thereof. In one embodiment the monomer is hydroxymethylated soy bean fatty acids or methyl esters thereof which may have an average OH functionality of between about 0.9 and about 1.1 per fatty acid, preferably, the functionality is about 1. In another embodiment the monomer is castor bean fatty acids. In another embodiment, the monomer may be a mixture of selected hydroxymethylated fatty acids or methylesters thereof.

Alternatively, the NOBP comprises certain polyols that comprise mer units based on methyl 9-(10)-hydroxymethylstearate (MHMS polyol). The embodiments of the invention may include NOBPs that have a relatively high content of methyl 9 (10) hydroxymethylstearate (hereinafter referred to as “MHMS”). Such NOBPs may comprise fatty acid based mer units wherein at least about 50, at least about 60, at least about 70, at least about 80, at least about 85, at least about 90, or at least about 95 weight percent of the fatty acid based mer units are from methyl 9 (10) hydroxymethylstearate. Methyl hydroxymethylstearate (CAS registry number 346706-54-5) is obtained by purchase, direct synthesis or synthesis from natural oils. Synthetic methods include those within the skill in the art and, for instance as disclosed in Behr, Arno; Fiene, Martin; Buss, Christian; Eilbracht, Peter, Hydroaminomethylation of fatty acids with primary and secondary amines—a new route to interesting surfactant substrates. European Journal of Lipid Science and Technology (2000), 102(7), 467-471; or DeWitt, Elmer J.; Ramp, Floyd L.; Backderf, Richard H. Hydroxymethylstearic acid polyester copolymers, U.S. Pat. No. 3,210,325 (1965).

Alternatively, a natural oil that produces fatty acids including oleic acid on saponification, for instance using a base such as sodium hydroxide is saponified. Then the fatty acids are purified or refined by methods within the skill in the art such as wiped film evaporator, distillation apparatus, simulated moving bed (SMB), and the like or combinations thereof to obtain at least about 80 weight percent oleic acid, preferably at least about 85, more preferably at least about 90, most preferably at least about 95 weight percent oleic acid in the resulting purified oil.

Alkyl esters are then optionally formed from the resulting fatty acids by any effective process such as those known in the art to produce hydroxyalkylesters of the fatty acids. For example, the hydroxymethyl group may be introduced by a hydroformylation process as described above.

Alternatively, the fatty acid ester feedstock is obtained by transesterifying a seed oil that contains oleic acid or purified oleic acid with a lower alkanol. Transesterification produces the corresponding mixture of fatty acid esters of the lower alkanol. Advantageously, the lower alcohol has from 1 to about 15 carbon atoms. The carbon atoms in the alcohol segment are optionally arranged in a straight-chain or alternatively in a branched structure, and are optionally inertly substituted. The alcohol may be a straight-chain or a branched C₁₋₈ alkanol, or a C₁₋₄ alkanol. In certain embodiments, the lower alkanol is selected from methanol, ethanol, and isopropanol.

Any known transesterification method can be suitably employed, provided that the ester products of the lower alkanol are achieved. The art adequately discloses transesterification (for example, methanolysis, ethanolysis) of seed oils; for example, refer to WO 2001/012581, DE 19908978, and BR 953081. Typically, in such processes, the lower alkanol is contacted with alkali metal, preferably sodium, at a temperature between about 30° C. and about 100° C. to prepare the corresponding metal alkoxide. Then, the seed oil is added to the alkoxide mixture, and the resulting reaction mixture is heated at a temperature between about 30° C. and about 100° C. until transesterification occurs.

Alternatively, the hydroxymethylated ester of fatty acids from a seed oil having a lower than desired oleic acid ester content are produced and the resulting hydroxymethylated fatty acid esters are purified by means within the skill in the art to contain the desired levels of oleic acid hydroxymethyl ester. Such methods include that disclosed in copending application “PURIFICATION OF HYDROFORMYLATED AND HYDROGENATED FATTY ALKYL ESTER COMPOSITIONS” filed Jun. 20, 2008, application number PCT/US08/67585, published as WO 2009/009271, which is incorporated by reference herein to the extent permitted by law. Alternatively, the polyol is prepared from reactions of purified chemicals, for instance the reaction of oleic acid with carbon monoxide via hydroformylation and subsequent hydrogenation to produce hydroxymethyl methylstearate followed by formation of the polyol.

The at least one NOBP may be the polyol obtained by reacting the hydroxymethylated monomer with an appropriate initiator compound to form a polyester or polyether/polyester polyol. Such a multi-step process is commonly known in the art, and is described, for example, in PCT publication Nos. WO 2004/096882 and 2004/096883. The multi-step process results in the production of a polyol with both hydrophobic and hydrophilic moieties, which results in enhanced miscibility with both water and conventional petroleum-based polyols.

The initiator for use in the multi-step process for the production of the natural oil derived polyols may be any initiator used in the production of conventional petroleum-based polyols. The initiator may be selected from the group consisting of neopentylglycol; 1,2-propylene glycol; trimethylolpropane; pentaerythritol; sorbitol; sucrose; glycerol; aminoalcohols such as ethanolamine, diethanolamine, and triethanolamine; alkanediols such as 1,6-hexanediol, 1,4-butanediol; 1,4-cyclohexane diol; 1,3-cyclohexanedimethanol, 1,4-cyclohexanedimethanol, 2,5-hexanediol; ethylene glycol; diethylene glycol, triethylene glycol; bis-3-aminopropyl methylamine; ethylene diamine; diethylene triamine; 9(1)-hydroxymethyloctadecanol, 1,4-bishydroxymethylcyclohexane; 8,8-bis(hydroxymethyl)tricyclo[5,2,1,0^{2,6}]decene; Dimerol alcohol (36 carbon diol available from Henkel Corporation); hydrogenated bisphenol; 9,9(10,10)-bishydroxymethyloctadecanol; 1,2,6-hexanetriol and combination thereof. In one embodiment, the initiator is a mixture of 1,3-cyclohexanedimethanol and 1,4-cyclohexanedimethanol and is commercially available under the trade name UNOXOL from The Dow Chemical Company which is an approximate 1:1 mixture of (cis, trans) 1,3-cyclohexanedimethanol and (cis, trans) 1,4-cyclohexanedimethanol. Other initiators include other linear and cyclic compounds containing an amine. Exemplary polyamine initiators include ethylene diamine, neopentyldiamine, 1,6-diaminohexane; bisaminomethyltricyclodecane; bisaminocyclohexane; diethylene triamine; bis-3-aminopropyl methylamine; triethylene tetramine various isomers of toluene diamine; diphenylmethane diamine; N-methyl-1,2-ethanediamine, N-Methyl-1,3-propanediamine, N,N-dimethyl-1,3-diaminopropane, N,N-dimethylethanolamine, 3,3′-diamino-N-methyldipropylamine, N,N-dimethyldipropylenetriamine, aminopropyl-imidazole.

In one embodiment, the initiators are alkoxlyated with ethylene oxide, propylene oxide, or a mixture of ethylene and at least one other alkylene oxide to give an alkoxylated initiator with a molecular weight between about 200 and about 6000, preferably between about 500 and about 5000. In one embodiment the initiator has a molecular weight of about 550, in another embodiment the molecular weight is about 625, and in yet another embodiment the initiator has a molecular weight of about 4600.

In one embodiment, at least one initiator is a polyether initiator having an equivalent weight of at least about 400 or an average at least about 9.5 ether groups per active hydrogen group, such initiators are described in copending Patent Application No. PCT/US09/37751 (published as WO/2009117630) the entire contents of which are incorporated herein by reference.

In some embodiments, the initiator is an initiator which has inherent crystallinity, due to intermolecular and intramolecular interactions, molecular weight, and preferred morphology at room temperature or a combination thereof. Such initiators include, but are not limited to poly(caprolactone), poly(pentadecalactone), poly(hydroxymethylundecylinic acid, poly(hexamethyladipamide), poly(oxytetramethylene), and other related diol, diacid, diamine, and isocyanate prepolymers. Such polyols are commercially available, for instance polycaprolactone polyols commercially available from The Dow Chemical Company under the trade designation TONE polyols, polyethylene glycol polyols commercially available from The Dow Chemical Company under the trade designation CARBOWAX, poly(tetramethylene ether) glycols from Invista under the trade designation TERATHANE or from BASF under the trade designation POLYTHF.

The functionality of the resulting NOBPs is above about 1.5 and generally not higher than about 2.7. In one embodiment, the functionality is about 2.

The NOBPs may constitute between about 10 weight % and 100% of the polyol composition. The NOBPs may constitute at least 10 weight %, 20 weight %, 30 weight %, 50 weight %, 60 weight %, 70 weight %, 75 weight %, 80 weight %, 85 weight %, 90 weight %, 95 weight %, or 99% of the polyol composition. The NOBPs may constitute up to about 60 weight %, 70 weight %, 75 weight %, 80 weight %, 85 weight %, 90 weight %, 95 weight %, or 100 weight % of the polyol composition.

The polyol composition may optionally include another kind of polyol, which includes at least one conventional petroleum-based polyol. Conventional petroleum-based polyols includes materials having at least one group containing an active hydrogen atom capable of undergoing reaction with an isocyanate, and not having parts of the material derived from a vegetable or animal oil. Suitable conventional petroleum-based polyols are well known in the art and include those described herein and any other commercially available polyol. Mixtures of one or more polyols and/or one or more polymer polyols may also be used to produce polyurethane products according to embodiments of the present invention.

Representative conventional petroleum-based polyols include polyether polyols, polyester polyols, polyhydroxy-terminated acetal resins, hydroxyl-terminated amines and polyamines. Alternative polyols that may be used include polyalkylene carbonate-based polyols and polyphosphate-based polyols. Preferred are polyols prepared by adding an alkylene oxide, such as ethylene oxide, propylene oxide, butylene oxide or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound. The initiators suitable for the natural oil based polyols may also be suitable for the at least one conventional petroleum-based polyol.

The at least one conventional petroleum-based polyol may for example be poly(propylene oxide) homopolymers, random copolymers of propylene oxide and ethylene oxide in which the poly(ethylene oxide) content is, for example, from about 1 to about 30% by weight, ethylene oxide-capped poly(propylene oxide) polymers and ethylene oxide-capped random copolymers of propylene oxide and ethylene oxide. The polyether polyols may contain low terminal unsaturation (for example, less that 0.02 meq/g or less than 0.01 meq/g), such as those made using so-called double metal cyanide (DMC) catalysts. Polyester polyols typically contain about 2 hydroxyl groups per molecule and have an equivalent weight per hydroxyl group of about 400-1500.

The conventional petroleum-based polyols may be a polymer polyol. In a polymer polyol, polymer particles are dispersed in the conventional petroleum-based polyol. Such particles are widely known in the art an include styrene-acrylonitrile (SAN), acrylonitrile (ACN), polystyrene (PS), methacrylonitrile (MAN), or methyl methacrylate (MMA) particles. In one embodiment the polymer particles are SAN particles.

The optional conventional petroleum-based polyols may constitute between about 0 weight % and 60 weight % of the total polyol composition, such as at least about 1 weight %, 5 weight %, 10 weight %, 20 weight %, 30 weight %, or 50 weight % of the total polyol formulation. and up to about 10 weight %, 20 weight %, 30 weight %, 40 weight %, 50 weight %, or 60 weight % of the total polyol composition.

The polyol composition may be reacted with an isocyanate to form at least one NCO terminated prepolymer. Suitable isocyanates for use in preparing the prepolymer include a wide variety of organic isocyanates. Suitable isocyanates include aromatic, cycloaliphatic and aliphatic isocyanates. Exemplary isocyanates include m-phenylene diisocyanate, toluene-2-4-diisocyanate, toluene-2-6-diisocyanate, isophorone diisocyanate, 1,3- and/or 1,4-bis(isocyanatomethyl)cyclohexane (including cis- or trans-isomers of either), hexamethylene-1,6-diisocyanate, tetramethylene-1,4-diisocyanate, cyclohexane-1,4-diisocyanate, hexahydrotoluene diisocyanate, methylene bis(cyclohexaneisocyanate) (H₁₂MDI), naphthylene-1,5-diisocyanate, methoxyphenyl-2,4-diisocyanate, diphenylmethane-4,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, a polymethylene polyphenylisocyanate (PMDI), toluene-2,4,6-triisocyanate and 4,4′-dimethyldiphenylmethane-2,2′,5,5′-tetraisocyanate. In some embodiments, the isocyanate is diphenylmethane-4,4′-diisocyanate, diphenylmethane-2,4′-diisocyanate, PMDI, toluene-2,4-diisocyanate, toluene-2,6-diisocyanate or mixtures thereof. Diphenylmethane-4,4′-diisocyanate, diphenylmethane-2,4′-diisocyanate and mixtures thereof are generically referred to as MDI, and all may be used. Toluene-2,4-diisocyanate, toluene-2,6-diisocyanate and mixtures thereof are generically referred to as TDI, and all may be used.

Derivatives of any of the foregoing isocyanate groups that contain biuret, urea, carbodiimide, allophonate and/or isocyanurate groups may also be used. These derivatives often have increased isocyanate functionalities and may often be used when a more highly crosslinked product is desired.

Additionally, the isocyanate used may be isocyanate terminated prepolymers such as polyether or polyester based prepolymers. Such isocyanate terminated prepolymers are available commercially, such as for example AIRTHANE prepolymers available from Air Products and Chemicals, Inc, and DIPRANE, ECHELON, ISONATE, and VORASTAR prepolymers available from the Dow Chemical Company.

The proportions of the isocyanate and the polyol composition are chosen to provide an isocyanate terminated prepolymer product. This may be accomplished by using excess stoichiometric amount of isocyanate, that is, more than one isocyanate group per active hydrogen group, preferably hydroxyl, amine and unreacted carboxyl group of the at least second polyol composition. The ratio of isocyanate groups to active hydrogen, more preferably hydroxyl and amine groups, on the polyol composition is preferably at least about 1.0, 1.2. 1.4, 1.5, 1.7, or 1.8, and independently at most about 10, at most about 6, at most about 3, at most about 2, at most 1.8, or at most 1.5. Higher (that is stoichiometric amounts or excess) isocyanate levels are optionally used.

Reaction of the at least second polyol composition with the isocyanate can be catalyzed using at least one catalyst within the skill in the art for such reactions. Examples of urethane catalysts include tertiary amines such as triethylamine, 1,4-diazabicyclo[2.2.2.]octane (DABCO), N-methylmorpholine, N-ethylmorpholine, N,N,N′,N′-tetramethylhexamethylene-diamine, 1,2-dimethylimidazol; and tin compounds such as tin(II)acetate, tin(II)octanoate, tin(II)laurate, dibutyltin dilaurate, dibutyltin dimaleate, dioctyltin diacetate and dibutyltin dichloride. In one embodiment the catalyst is benzoyl chloride. The catalysts are optionally used alone or as mixtures thereof. The reaction may be heated to temperatures between 20° C. and 100° C., and may take 1-6 hours to complete.

The NCO terminated prepolymer may be reacted with an amino functional alkoxysilane to form at least one silyl polymer having at least one crosslinkable silyl group, at least one urethane group, and at least one urea group in each molecule. The amino-functional alkoxysilane may be represented by general formula (I)

X₃₋ₐSi(R¹)ₐ—R²—N(R³)—H. (1)

a is 0 or 1. R¹ is a monovalent hydrocarbon of C₁-C₂₀ alkyl (including methyl, ethyl, and the like), cycloalkyl groups (such as cyclohexyl and the like), alkenyl (such as vinyl and propeny, and the like), or an aryl (such as phenyl and the like). In certain embodiments, R¹ is a C₁-C₆ monovalent hydrocarbon group. R² represents C₁-C₂₀ or C₁-C₁₀ divalent hydrocarbyl or a divalent organic group represented by —R⁴—NH—R⁵—. The C₁-C₂₀ or C₁-C₁₀ divalent hydrocarbyl can be exemplified by alkylene such as methylene, ethylene, propylene, butylene, —(CH₂)₆—, —(CH₂)₈—, —(CH₂)₁₀—, and —CH₂CH(CH₃)—CH₂—; phenylene; and

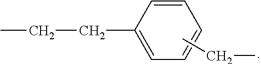

The divalent organic group represented —R⁴—NH—R⁵— (wherein R⁴ and R⁵ represent the same C₁-C₂₀ or C₁-C₁₀ divalent hydrocarbyl as for the aforementioned R²) is exemplified by the following.

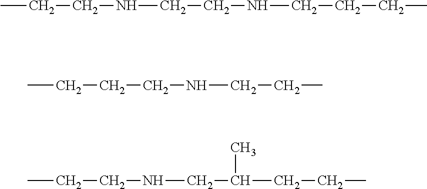

R³ is H or monovalent hydrocarbon group C₁-C₆ or C₁-C₃. Each X is independently a hydrolyzable group. Each hydrolyzable group is, independently, selected from a halogen atom (such as Cl, or Br), an alkoxy group (such as methoxy, ethoxy, propoxy, butoxy, —O—CH(CH₃)—CH₃, —O—CH₂—CH(CH₃)—CH₃, or —O—CH(CH₃)—CH₂—CH₃), a ketoxime group, or the like, or a combination thereof.

Relative amounts of isocyanate functional prepolymer and amino functional alkoxysilane for reaction are those amounts which result in the desired or predetermined extent of reaction. Too much silane could negatively affect mechanical properties, specifically tensile strength and elongation at break, of the cured elastomer. In one embodiment, a stoichiometric amount of silane is added to silylate all of the NCO substituents on the MHMS isocyanate functional polyol. In embodiments of the invention, a stoichiometric ratio (amine/NCO) is at least about 0.70, at least about 0.0.85, or at least about 0.95 and at most about 1.3, at most about 1.20, or at most about 1.10.

The reaction of the amino functional alkoxysilane and isocyanate functional prepolymer takes place under reactions conditions, that is, any conditions under which the reaction is effective. The reaction of the amino functional alkoxysilane and isocyanate functional prepolymer may occur at temperatures of least about 0° C., at least about 20° C., at least about 30° C., or at least about 55° C., and at most about 100° C., at most about 85° C., or at most about 60° C.

According to the embodiments of the invention, the resulting silyl polymers may be useful, among other things, to be reacted with one another to further lengthen the molecular chains for uses such as sealants, adhesives, and coatings, and combinations thereof. When silyl polymers are exposed to moisture, for example, the moisture from the atmosphere, the hydrolyzable groups which are bonded to the silicon atoms are hydrolyzed, being replaced by silicon bonded hydroxyl groups. The hydroxyl groups in turn react with each other or with other hydrolyzable groups to form siloxane (Si—O—Si) linkages. By this process the polymer molecules of the composition of the embodiments of the invention are bonded to form an infusible elastomeric material. To avoid premature curing, the compositions of the embodiments of the invention may be stored and maintained in the absence of moisture until cure is desired. Then, when cure is desired, the polymer may be exposed to atmospheric or other moisture.

Furthermore, the reaction of curing of the silyl polymer may be facilitated by use of a silanol condensation catalyst or curing accelerator. Silanol condensation catalysts or accelerators are well known in the art such as those disclosed in U.S. Pat. No. 6,355,127 and include the following: titanic acid esters, such as tetrabutyl titanate, tetrapropyl titanate, and the like; organotin compounds, such as dibutyltin dilaurate, dibutyltin maleate, dibutyltin diacetate, tin octylate, tin naphthenate, reaction products of dibutyltin oxide and phthalic acid esters, dialkyltin diacetyl acetonates, such as dibutyltin bis(acetylacetonate); dialkyltinoxides, such as dibutyltinoxide; organoaluminum compounds, such as aluminum trisacetylacetonate, aluminum trisethylacetonate, and the like; reaction products, such as bismuth salts and organic carboxylic acids, such as bismuth tris(2-ethylhexoate), bismuth tri(neodeconate), and the like; chelate compounds, such as zirconium tetracetylacetonoate, titanium tetracetylacetonate, and the like; amine compounds, such as butylamine, octylamine, dibutylamine, monethanolamine, diethanolamine, triethanolamine, diethylenetriamine, cyclohexylamine, benzylamine, and the like, or their salts with carboxylic acids, and the like. These compounds are not limited; one can use any silanol condensation catalyst which is in general use. These silanol condensation catalysts may be used individually or in combinations. Such catalysts and accelerators include tetrabutyltitanate, dibutyltin dilaurate, dibutyltin bis(acetylacetonate), and the like. The catalyst may be present in an amount of about at least about 0.1 percent by weight of the polymer, at least about 0.5 percent by weight of the polymer, at least about 1 percent by weight of the polymer, at least about 1.5 percent by weight of the polymer, or at least about 2 percent by weight of the polymer and at most about 8 percent by weight of the polymer, at most about 6 percent by weight of the polymer, at most about 5 percent by weight of the polymer, at most about 4 percent by weight of the polymer, or at most about 3.5 percent based on weight of the polymer. Such catalysts may be combined with the polymer by means within the skill in the art during the formulation of the sealant, coating, or adhesive.

The resulting cured silyl polymers are also embodiments of the invention. Similarly, the embodiments of the invention includes the sealants, adhesives, and coatings and other end uses comprising these polymers or prepolymers. Preferred properties for the silyl polymers may differ somewhat for each end use as do other components that are optionally present in compositions suitable for each.

Crosslinking or cure of the silyl polymers results in an elastic thermoset polymer. Tensile strength for sealants, coatings and adhesives as measured according to the procedures of ASTM D412, may be at least about 0.25 MPa, at least about 0.5 MPa, at least about 1.0 MPa, at least about 2.5 MPa, or at least about 5.0 MPa, and, independently, at most about 10 MPa, at most about 8 MPa, at most about 6 MPa, or at most about 5 MPa. For sealants and adhesives elongation as measured according to the procedures of ASTM D412, may be at least about 50 percent, at least about 100 percent, at least about 150 percent, or least about 175 percent and, independently, at most about 1000 percent, at most about 900 percent, at most about 750 percent, at most about 500 percent, or at most about 300 percent. For coatings, elongation as measured according to the procedures of ASTM D412, is at least about 10 percent, at least about 25 percent, at least about 50 percent, at least about 100 percent, and, independently, at most about 500 percent, at most about 200 percent, or at most about 100 percent.

For use in sealants and adhesives, the silyl polymers may have an average NCO functionality of at least about 1.5, at least about 2, or at least about 2.2 and at most about 3, at most about 2.8, or at most about 2.7. Independently, the silyl polymers may have a number average molecular weight of at least about 7500, at least about 9000, or at least about 10000 and at most about 25000, at most about 20000, or at most about 15000.

For formulating sealant, coating, and adhesive compositions, the silyl polymers are combined with fillers and additives known in the prior art for use as elastomeric compositions. Addition of such materials, physical properties such as viscosity, flow rate, sag, and the like and mechanical properties such as modulus, elongation, hardness, and the like can be modified. However, to prevent premature hydrolysis of the moisture sensitive groups of the polymer, the filler may be thoroughly dried before admixing. Exemplary filler materials such as calcium carbonate, titanium dioxide, carbon black, clays, fumed silica, precipitated silica, magnesium carbonate, diatomaceous earth, talc, zinc oxide, ferric oxide, and the like. The fillers may be used singly or in combination. This list is not comprehensive and is given as illustrative. However, fillers such as calcium carbonate, titanium dioxide, zinc oxide, and carbon black are Depending on the desired workability and properties of the cured material the preferred filler level is at least about 3, or about 10 parts per 100 parts by weight of prepolymer and at most about 250, or about 200 parts per 100 parts of prepolymer. In addition to fillers, additives such as plasticizers, moisture scavengers, adhesion promoters, antioxidants, ultraviolet stabilizers, and the like can also be used in the sealant compositions.

Additives such as plasticizers may be used in combination with the above fillers to modify the rheological properties to a desired level. Plasticizers may be used individually or in combination. Such materials should be free of water, inert to the hydrolyzable groups on the polymer, and compatible with the polymer. Suitable plasticizers are well known in the prior art and include phthalate acid esters, such as dioctyl phthalate, diisononyl phthalate, butyl benzyl phthalate, and the like; phosphoric acid esters, such as tri-cresyl phosphate; polyethers, polybutenes, and plasticizers based on epoxy compounds, such as epoxidized soybean oil, aliphatic esters, and chlorinated paraffin, and the like. The amount of plasticizers are preferably at least about 1, at least about 15, or at least about 25 and at most about 150, at most about 100, and or at most about 75 parts by weight, based on 100 parts by weight of the silylated prepolymer.

For use in coatings, the silyl polymers preferably have an average NCO functionality of at least about 1.5, at least about 2, or at least about 2.5, and at most about 3, at most about 2.8, or at most about 2.7. Independently, the silyl polymers have an molecular weight of at least about 1000, at least about 2500, or at least about 5000 and at most about 30000, at most about 25000, or at most about 17000.

Coatings optionally contain additives within the skill in the art such as fillers, flow additives, and those used in sealants. In addition, coatings generally include at least one solvent. The solvent is optionally any aprotic solvent which will dissolve or disperse the MHMS alkoxysilane prepolymer. The optional solvent is used to adjust viscosity to provide a formulation suitable for coating, preferably having a viscosity of from about 10 centipoise to about 10 poise. In many cases, a single solvent is used to solubilize the system. However, in other cases it is often desirable to use mixtures of solvents in order to effect the best solubilization, and in particular a combination of an aromatic solvent with an oxygenated solvent is preferred. Suitable aromatic solvents include toluene, xylene, ethylbenzene, tetralin, naphthalene, and solvents which are narrow cut aromatic solvents comprising C8 to C13 aromatics such as those marketed by Exxon Company U.S.A. under the trade designation AROMATIC 100, AROMATIC 150, and AROMATIC 200. Suitable oxygenated solvents can be selected from the following classes: ketones, ethers, and ether-esters, or any mixture of these. Examples of suitable oxygenated solvents include propylene glycol monomethyl ether acetate, propylene glycol propyl ether acetate, ethoxypropionate, dipropylene glycol monomethyl ether acetate, propylene glycol monomethyl ether, propylene glycol monopropyl ether, dipropylene glycol monomethyl ether, diethylene glycol monobutyl ether acetate, ethylene glycol monoethyl ether acetate, ethylene glycol monobutyl ether acetate, ethylene glycol monoethyl ether, ethylene glycol monobutyl ether, diethylene glycol monoethyl ether, diethylene glycol monoethyl ether acetate, dibasic ester (a mixture of esters of dibasic acids marketed by DuPont), ethyl acetate, n-propyl acetate, isopropyl acetate, butyl acetate, isobutyl acetate, amyl acetate, isoamyl acetate, mixtures of hexyl acetates such as those sold by Exxon Chemical Company under the brand name EXXATE 700, acetone, methyl ethyl ketone, methyl isobutyl ketone, methyl amyl ketone, methyl isoamyl ketone, methyl heptyl ketone, and isophorone. The list should not be considered as limiting, but rather as examples of solvents which are useful in the present invention. The type and concentration of solvents are generally selected to obtain formulation viscosities and evaporation rates suitable for the application and cure of the coatings. Typical solvent concentrations in the formulations range from 0 to about 75 percent by weight, between about 5 and 50 percent by weight, or between about 10 and 40 percent by weight solvent in the composition of solvent, prepolymer, polymer or combination thereof, fillers, additives and other components.

### EXAMPLES

The following examples are provided to illustrate the embodiments of the invention, but are not intended to limit the scope thereof. All parts and percentages are by weight unless otherwise indicated. Examples of embodiments of the invention are numbered while comparative samples, which are not examples of embodiments of the invention, are designated alphabetically.

The following materials were used:
Amine 1 is ethylaminoisobutyltrimethoxysilane commercially available from Momentive Performance Materials under the trade designation A-Link 15.
Amine 2 is methylaminopropylmethyldimethoxysilane commercially available from Gelest, Inc.
Amine 3 is N-(n-butyl)-3-aminopropyltrimethoxysilane commercially available from Degussa under the trade designation Dynasylan 1189.
Methyl stearate is commercially available from Sigma-Aldrich.
DBTDL is dibutyltindilaurate commercially available from Aldrich Chemical Company.
DBTO is a dibutyltin oxide commercially available from Sigma-Aldrich.
ADD-1 is a linear phthalate ester plasticizer, commercially available from BASF Corporation under the trade designation Palatinol 711P.
CaCO₃ is calcium carbonate commercially available from Omya Inc. under the trade designation Omyacarb UF-FL.
TiO₂ is titanium dioxide commercially available from DuPont under the trade designation Ti Pure R900.
PTMEG-1 is a Poly(tetramethylene ether glycol) with molecular weigst of 2825-2975 and hydroxyl numbers of 40-38, available from Invista under the trade designation TERATHANE 2900.
PTMEG-2 is a Poly(tetramethylene ether glycol) with molecular weights of 625-675 and hydroxyl numbers of 180-166, available from Invista under the trade designation TERATHANE 650.
VTMS is vinyl trimethoxy silane commercially available from Dow Corning under the trade designation Z-6300.
DBTDAA is dibutyl tin diacetylacetonate commercially available from Aldrich Chemical Company.
PET-95A is a TDI-Polyether Prepolymer commercially available from Air Products and Chemicals, Inc. under the trade designation AIRTHANE PET-95A.
TDI is a toluene diisocyanate (80% 2,4-toluene diisocyanate and 20% 2,6-toluene diisocyanate by weight) composition available from The Dow Chemical Company under the trade designation VORANATE T-80.
Dioxane is 1,4-dioxane available from Sigma-Aldrich.
   Poly(HMS) polyol 1-4

Four hydroxymethylated mixtures of fatty acid esters were obtained from soybean oil as described in WO2004/096882 and was purified by the process described in WO2009/009271. The four mixtures includes a majority by weight of methyl 9-(10)-hydroxymethylstearate (MHMS, or “monol”), and the resulting compositions of the four MHMS mixtures are given in Table 1.

TABLE 1

| | MHMS A | MHMS B | MHMS C | MHMS D |
|---|---|---|---|---|
| Methyl Stearate | 0.96% | 1.97% | 0.33% | 0.86% |
| Methyl Palmitate | 0.09% | 0.10% | 0.08% | 0.00% |
| Monols | 90.94% | 95.89% | 52.52% | 94.24% |
| Diols | 5.14% | 0.40% | 43.66% | 3.00% |
| Triols | 0.00% | 0.00% | 0.00% | 0.00% |
| Lactols/Cyclic ethers | 1.68% | 1.63% | 2.61% | 1.86% |
| Lactones | 0.08% | 0.00% | 0.79% | 0.05% |
| Dimer | 1.11% | 0.00% | 0.00% | 0.00% |

The MHMS, methyl stearate, and PTMEG were charged to a three-neck round-bottom flask equipped with a mechanical stirrer, a condenser, a Dean-Stark trap, a nitrogen inlet, and a water condenser. The amounts of each component are given in Table 2. The flask was evacuated and backfilled with nitrogen three times at room temperature. The flask content was then heated to 100° C. Under nitrogen DBTO catalyst was added and the reaction mixture was heated to 195° C. while methanol was collected. After approximately 2 hours, the temperature was increased to 205° C. until methanol collection trailed off. Nitrogen supply was then shut off and a high vacuum applied while maintaining the temperature at 205° C. for about 1 to 2 hours. The reaction mixture was cooled to room temperature and stored in an inert dry atmosphere under a nitrogen blanket.

TABLE 2

| | Poly(HMS) | Poly(HMS) | Poly(HMS) | Poly(HMS) |
|---|---|---|---|---|
| | polyol 1 | polyol 2 | polyol 3 | polyol 4 |
| MHMS A (g) | 14.6 | | 900 | |
| MHMS B (g) | 95 | 149.98 | | |
| MHMS C (g) | | 11 | | |
| MHMS D (g) | | | | 200.03 |
| Methyl | 0.1 | 1 | 30.3 | 2.23 |
| stearate (g) | | | | |
| DBTO, (g) | 0.1491 | 0.1773 | 1.0263 | 2.7307 |
| PTMEG-1 (g) | 39.96 | | | 72.02 |
| PTMEG-2(g) | | 17.6 | 101.9 | |
| polymer Mn | 10387 | 7160 | 7390 | 10210 |
| Polymer | 1.72 | 2.62 | 2.67 | 2.07 |
| Functionality | | | | |

### Poly(HMS) Prepolymer 1-3

A 250 mL 3-neck roundbottom flask was equipped with nitrogen inlet, thermocouple-controlled oil bath, and mechanical stirrer. The flask was charged with PET 95A to react with the terminal hydroxyl groups of the linear poly(HMS) polyol. The calculation indexed the diisocyanate to have a single residual unreacted isocyanate function per poly(HMS) hydroxyl, the amounts used is given in Table 3. The poly(HMS) polyol was charged to the jacketed, heated (80° C.) addition funnel for slow addition to the stirring prepolymer at 80° C. As the poly (HMS) polyol was added drop-wise to the stirred PET 95A, the temperature was maintained at 80° C. for 3 hours, to allow for complete reaction time. This process was designed to allow the early excess isocyanate end groups in the pot to produce statistically higher amounts of PET 95A-poly(HMS) Polyol-PET 95A materials, each having dual terminal isocyanate functions. The molecular weight of each chain was thereby increased by about twice the molar mass of the PET 95A, on average. The new triblock was transferred to a glass container, sealed under nitrogen atmosphere, and stored in a controlled inert atmosphere.

TABLE 3

| | Poly(HMS) | Poly(HMS) | |
|---|---|---|---|
| | Polyol No | Polyol (g) | PET 95A (g) |
| Poly(HMS) | Poly(HMS) | 50.7 | 12.5 |
| Prepolymer 1 | polyol 1 | | |
| Poly(HMS) | Poly(HMS) | 128.6 | 41.1 |
| Prepolymer 2 | polyol 2 | | |
| Poly(HMS) | Poly(HMS) | 201.9 | 81.9 |
| Prepolymer 3 | polyol 3 | | |

### Poly(HMS) Prepolymer 4

TDI (2.82 g) was diluted in dioxane solvent (50 g) in a 3-neck 1.0 L flask equipped with a nitrogen inlet, mechanical stirrer, and jacketed addition funnel for the Poly(HMS) polyol addition. Poly(HMS) polyol 4 (80.0 g) was dissolved in dioxane (100 g) and transferred to the jacketed addition funnel. The recirculation bath temperature was set to 75° C. This temperature was maintained for the entire addition of the poly(HMS) polyol. The TDI solution was heated in the flask to 80° C. under nitrogen pad. After equilibration of temperatures, the poly(HMS) polyol solution was gradually added to the stirring flask dropwise. The mechanical agitation was set at a high rate, and addition was complete within 40 minutes. The mixing and heating was continued at 80° C. over 2 hours after complete addition. The final product was poured into a separate container under nitrogen atmosphere and stored in an inert atmosphere.

### Examples A-K

For Examples A-I, the amount of Poly(HMS) Prepolymer indicated in Table 4 was placed in a glass bottle. The indicated amount and type of amino silane was added along with ADD-1, if present, during the silylation. The materials were mixed by hand using a spatula until the resulting admixture appeared homogeneous. The bottle was purged with nitrogen and sealed, then placed in an oven at the specified temperature(s) and time(s).

For Examples J and K, the amount of Poly(HMS) Prepolymer indicated in Table 2 and ADD-1 were placed in a cup commercially available from FlackTek, Inc. under the trade designation MAX 20 cup and mixed using a dual asymmetric centrifuge mixer commercially available from FlackTek, Inc. under the trade designation DAC 150 FVZ-K SPEEDMIXER for 30 seconds at a speed of 2400 rpm to complete a first mixing. This mixer works by placing a cup in a basket where a mixing arm spins at a high speed (up to 3300 rpm) in one direction while the basket rotates in the opposite direction—hence dual asymmetric centrifuge. The combination of forces in different planes enables very fast mixing. The indicated amount and type of amino silane was added to the cup and mixed for 30 seconds at 2400 rpm. The material was then placed in a glass bottle and is purged with nitrogen and sealed, then placed in an oven at the specified temperature(s) and time(s).

After the specified time(s) and temperature(s) sealant formulations were prepared and tested. The amount of MHMS akoxysilane prepolymer and ADD-1 were placed in a cup commercially available from FlackTek, Inc. under the trade designation MAX 60 cup and mixed for 30 seconds at a speed of 2400 rpm to complete a first mixing. The indicated amounts of CaCO₃ and TiO₂ were premixed then added to the mixing cup and mixed by hand using a spatula until wet, then for twice as long at the same speed as the first mixing. The contents were mixed by hand with a spatula to remove material from the side of the cup. The material was mixed for 30 seconds at 2400 rpm. The amounts of VTMS and DBTDAA indicated in Table 2 were added and mixed into the cup, first by hand then at the same speed and for the same time as the first mixing to form a sealant composition.

Films were cast from each sealant composition by hand with a spatula to produce films having a thickness between ⅛ and 1/16 inch (1.5-3.2*mm) The films were cured at 50 percent relative humidity for 7 days at approximately 22° C. Then tensile strength at break was measured according to the procedures of ASTM D412, and Elongation at break was measured according to the procedures of ASTM D412 using an instrument commercially available from Instron under the trade designation INSTRON Model 1122 at a strain rate of 1″/min (2.54 mm/sec).

TABLE 4

| | A | B | C | D | E | F | G | H | I | J | K |
|---|---|---|---|---|---|---|---|---|---|---|---|
| Poly(HMS) | 12 | | | | | | | | | | |
| Prepolymer 1 (g) | | | | | | | | | | | |
| Poly(HMS) | | 13 | 13 | | | | | | | | |
| Prepolymer 2 (g) | | | | | | | | | | | |
| Poly(HMS) | | | | 13 | 13 | 13 | 13 | 13 | 13 | | |
| Prepolymer 2 (g) | | | | | | | | | | | |
| Poly(HMS) | | | | | | | | | | 13 | 13 |
| Prepolymer 3 (g) | | | | | | | | | | | |
| ADD-1 (g) | 2.75 | 3 | 3 | | | | | | | 3.72 | 3.69 |
| Amine 1 (g) | 0.39 | 0.53 | | 0.54 | | | 0.66 | | | 0.57 | |
| Amine 2 (g) | | | 0.43 | | 0.43 | | | 0.52 | | | 0.46 |
| Amine 3 (g) | | | | | | 0.58 | | | 0.70 | | |
| Stoichiometric | 1 | 1 | 1 | 0.77 | 0.77 | 0.77 | 1 | 1 | 1 | 1.02 | 1.02 |
| Ratio Amine/NCO | | | | | | | | | | | |
| DBTDL (drops) | 1 | 0 | 0 | 0 | 0 | 0 | 0 | 0 | 0 | 0 | 0 |
| Temp ° C./Time | 93/1 & | 80/1 & | 82/1 & | 80/1.5 & | 80/1.5 & | 80/1.5 & | 80/1 & | 80/1 & | 80/1 & | 55/6 | 55/6 |
| (hrs) | 55/3 | 55/2 | 22/16 | 22/16 | 22/16 | 22/16 | 22/3 | 22/3 | 22/3 | | |
| parts of prepolymer | 100 | 100 | 100 | 100 | 100 | 100 | 100 | 100 | 100 | 100 | 100 |
| by weight | | | | | | | | | | | |
| ADD-1 (php) | 47 | 42 | 42 | 27 | 27 | 27 | 27 | 27 | 27 | 62 | 62 |
| CaCO3 (php) | 120 | 120 | 120 | 120 | 120 | 120 | 120 | 120 | 120 | 153 | 153 |
| TiO2 (php) | 20 | 20 | 20 | 20 | 20 | 20 | 20 | 20 | 20 | 25 | 25 |
| VTMS (php) | 2.0 | 2.0 | 2.0 | 2.0 | 2.0 | 2.0 | 2.0 | 2.0 | 2.0 | 2.5 | 2.5 |
| DBTDAA (php) | 2.0 | 2.0 | 2.0 | 2.0 | 2.0 | 2.0 | 2.0 | 2.0 | 2.0 | 2.5 | 2.5 |
| Humidity % | 50 | 50 | 50 | 50 | 50 | 50 | 50 | 50 | 50 | 50 | 50 |
| Tensile at break MPa | 1 | 1.4 | 1.6 | 1.4 | 1.4 | 1.4 | 1.7 | 1.4 | 1.2 | 1.7 | 1.1 |
| Elongation at break % | 255 | 131 | 187 | 96 | 107 | 80 | 80 | 106 | 63 | 194 | 127 |

Examples D-I illustrate how lower plasticizer levels at the same filler and catalyst loading yield lower elongations versus Examples A-C. Examples D-F, with less than a stoichiometric amount of aminosilane, provide the same mechanical properties as a stoichiometric amount of aminosilane, Examples G-I. Examples A and J illustrate that with A-Link 15 a good balance of mechanical properties (tensile strength and elongation) is obtained.

While the foregoing is directed to embodiments of the present invention, other and further embodiments of the invention may be devised without departing from the basic scope thereof, and the scope thereof is determined by the claims that follow.

1. A method of producing a silyl polymer, the method comprising:
reacting at least one natural oil based polyol with at least one isocyanate to form at least one prepolymer having at least one NCO group, wherein the at least one natural oil based polyol comprises the reaction product of hydroxymethylated fatty acids or esters thereof and at least one polyol initiator; and
reacting the prepolymer having at least one NCO group with at least one amino functional alkoxy silane to form the silyl polymer, such that the silyl polymer comprises at least one crosslinkable silyl group, at least one urethane group, and at least one urea group in each molecule.

2. A silyl polymer, comprising the reaction product of at least:
a) at least one prepolymer having at least one free NCO group, the at least one prepolymer comprising the reaction product of at least one natural oil based polyol and at least one isocyanate, wherein the at least one natural oil based polyol comprises the reaction product of hydroxymethylated fatty acids or esters thereof and at least one polyol initiator; and
b) at least one amino functional alkoxy silane, wherein the silyl polymer comprises at least one crosslinkable silyl group, at least one urethane group, and at least one urea group in each molecule.

3. The method of claim 1, wherein at least about 50 weight percent of the hydroxymethylated fatty acids or esters thereof comprises methyl 9 (10) hydroxymethylstearate.

4. The method of claim 3, wherein at least about 80 weight percent of the hydroxymethylated fatty acids or esters thereof comprises methyl 9 (10) hydroxymethylstearate.

5. The method of claim 1, wherein the hydroxymethylated fatty acids or esters thereof is prepared from an oil having fatty acids or fatty acid esters which are at least about 80 weight percent oleic acid or esters thereof and which has an average hydroxyl functionality of from 1.5 to 4.

6. The method of claim 1, wherein the at least one isocyanate comprises a NCO-terminated polyether prepolymer.

7. The method of claim 1, wherein the polyol initiator comprises a poly(tetramethylene ether glycol).

8. The method of claim 1, further comprising curing the silyl polymer with water.

9. The method of claim 1, wherein the silyl polymer is cured with water and has a Tensile strength as measured according to the procedures of ASTM D412 of at least about 0.25 MPa.

10. The method of claim 9, wherein the silyl polymer has an elongation as measured according to the procedures of ASTM D412 of at least about 10 percent.

11. An article comprising the cured silyl polymer of claim 8.

12. The article of claim 11 wherein the article is an elastomer, a sealant, an adhesive, a coating or a combination thereof.

13. The silyl polymer of claim 2, wherein at least about 50 weight percent of the hydroxymethylated fatty acids or esters thereof comprises methyl 9(10) hydroxymethylstearate.

14. The silyl polymer of claim 13, wherein at least about 80 weight percent of the hydroxymethylated fatty acids or esters thereof comprises methyl 9(10) hydroxymethylstearate.

15. The silyl polymer of claim 2, wherein the hydroxymethylated fatty acids or esters thereof is prepared from an oil having fatty acids or fatty acid esters which are at least about 80 weight percent oleic acid or esters thereof and which has an average hydroxyl functionality of from 1.5 to 4.

16. The silyl polymer of claim 2 wherein the at least one isocyanate comprises a NCO-terminated polyether prepolymer.

17. The silyl polymer of claim 2 wherein the polyol initiator comprises a poly(tetramethylene ether glycol).

18. The silyl polymer of claim 2 wherein the silyl polymer is cured with water and has a Tensile strength as measured according to the procedures of ASTM D412 of at least about 0.25 MPa.

19. The silyl polymer of claim 18 wherein the silyl polymer has an elongation as measured according to the procedures of ASTM D412 of at least about 10 percent.
